(19) United States
(12) Patent Application Publication
(10) Pub. No.: US 2025/0175464 A1
(43) Pub. Date: May 29, 2025

(54) Detecting A Malicious Multifactor Authentication Device Registration

(71) Applicant: Cisco Technology, Inc., San Jose, CA (US)

(72) Inventors: Joseph Cleary Duggan, Ann Arbor, MI (US); Michael Thaddeus Moran, Brooklyn, NY (US); Joshua Ryan Terry, Round Rock, TX (US); Alan I. Pinkert, Boston, MA (US); John F. Huffman, Raleigh, NC (US); Jeremy T. Jordan, Cary, NC (US)

(21) Appl. No.: 18/520,200

(22) Filed: Nov. 27, 2023

(51) Int. Cl. H04L 9/40

(52) U.S. Cl. CPC H04L 63/0876; H04L 63/1416; H04L 63/20

(57) ABSTRACT

In one embodiment, a method includes receiving a request for registering a device that is to be used for MFA of an account, receiving a plurality of device properties from the device, retrieving a plurality of account properties, calculating a likelihood for the device registration being malicious by processing the plurality of device properties and the plurality of account properties with one or more pre-determined rules and with one or more pre-trained machine-learning models, determining that the likelihood exceeds a pre-determined threshold, and sending a notification indicating that the likelihood for the device registration being malicious exceeds the pre-determined threshold in response to determining that the likelihood exceeds the pre-determined threshold.

### TECHNICAL FIELD

The present disclosure relates generally to security in information systems, and more particularly, to detecting a malicious multifactor authentication device registration.

### BACKGROUND

Multi-factor authentication (MFA) is an electronic authentication method in which a user is granted access to an information system only after the user successfully presents two or more pieces of evidence to an authentication mechanism. MFA is a widely used method to protect information systems. The security of multifactor authentication may be predicated on the registration of authentication devices that are in the possession of the intended, trusted end user. When malicious actors register their own authentication device for MFA of an account, the authentication device may present a security risk to the information system because all subsequent authentication events for the account will have a higher chance of access and a lower chance of detection by security teams. In large environments, authenticator registrations may be a high-frequency event. Thus, reviewing these events for the threat may not be feasible.

### BRIEF DESCRIPTION OF THE DRAWINGS

FIG. 1 illustrates an example logical architecture for determining whether a device is malicious when the device is being registered to be used for MFA of an account.

FIG. 2 illustrates an example message flow for determining whether a device is malicious when the device is being registered to be used for MFA of an account.

FIG. 3 illustrates an example method for determining whether a device is malicious when the device is being registered to be used for MFA of an account.

FIG. 4 illustrates an example computing system.

### DESCRIPTION OF EXAMPLE EMBODIMENTS

### Overview

In one or more embodiments, a method may include receiving a request for registering a device that is to be used for multi-factor authentication (MFA) of an account. The method may include receiving a plurality of device properties from the device. The method may include retrieving a plurality of account properties. The method may include calculating a likelihood for the device registration being malicious by processing the plurality of device properties and the plurality of account properties with one or more pre-determined rules and with one or more pre-trained machine-learning models. The method may include determining that the calculated likelihood exceeds a pre-determined threshold. The method may further include sending a notification indicating that the calculated likelihood for the device registration being malicious exceeds the pre-determined threshold in response to the determination.

In particular embodiments, a system may include one or more processors and a non-transitory memory coupled to the one or more processors. The non-transitory memory may include instructions executable by the one or more processors. The one or more processors may be operable when executing the instructions to receive a request for registering a device that is to be used for MFA of an account. The one or more processors may be operable when executing the instructions to receive a plurality of device properties from the device. The one or more processors may be operable when executing the instructions to retrieve a plurality of account properties. The one or more processors may be operable when executing the instructions to calculate a likelihood for the device registration being malicious by processing the plurality of device properties and the plurality of account properties with one or more pre-determined rules and with one or more pre-trained machine-learning models. The one or more processors may be operable when executing the instructions to determine that the calculated likelihood exceeds a pre-determined threshold. The one or more processors may be further operable when executing the instructions to send, in response to the determination, a notification indicating that the calculated likelihood for the device registration being malicious exceeds the pre-determined threshold.

In one or more embodiments, one or more computer-readable non-transitory storage media may embody software that is operable when executed to receive a request for registering a device that is to be used for MFA of an account. The software may be operable when executed to receive a plurality of device properties from the device. The software may be operable when executed to retrieve a plurality of account properties. The software may be operable when executed to calculate a likelihood for the device registration being malicious by processing the plurality of device properties and the plurality of account properties with one or more pre-determined rules and with one or more pre-trained machine-learning models. The software may be operable when executed to determine that the calculated likelihood exceeds a pre-determined threshold. The software may be further operable when executed to send, in response to the determination, a notification indicating that the calculated likelihood for the device registration being malicious exceeds the pre-determined threshold.

### Example Embodiments

In particular embodiments, a system may determine whether a device is malicious when the device is being registered to be used for MFA of an account. MFA is an electronic authentication method in which a user is granted access to an information system only after the user successfully presents two or more pieces of evidence to an authentication mechanism. MFA is a widely used method to protect information systems. The security of multifactor authentication may be predicated on the registration of authentication devices that are in the possession of the intended, trusted end user. When malicious actors register their own authentication device for MFA of an account, the authentication device may present a security risk to the information system because all subsequent authentication events for the account will have a higher chance of access and a lower chance of detection by security teams. For example, after obtaining access to the information system with the registered authentication device, the malicious actors may send internal emails to the users of the information system requesting authentication-related information. Many recipients may click links in the email without suspecting integrity of the email because the email was sent by an internal member. For another example, after obtaining access to the information system with the registered authentication device, the malicious actors may alter, copy, download, destroy, or otherwise compromise data stored in the information system in such a way as to make the data unusable by the account or the organization of the account. This data may include personal information, financial information, intellectual property, or any other assets stored within the information system. For yet another example, after obtaining access to the information system with the registered authentication device, the malicious actors may alter, destroy, or otherwise compromise the information system in such a way to make the information system inoperable or operate in a manner unintended by the account or the organization of the account. In large environments, authenticator registrations may be a high-frequency event. Thus, reviewing these events for the threat may not be feasible. An authentication system disclosed herein may collect information associated with a device and information associated with an account when the device is being registered to be used for MFA of the account. The authentication system may calculate a likelihood for the device registration being malicious by processing the collected information with one or more pre-determined rules and with one or more pre-trained machine-learning models. When the calculated likelihood is higher than a pre-determined threshold, the authentication system may send a notification to a computing system associated with an administrator so that the administrator can take further action on the device registration.

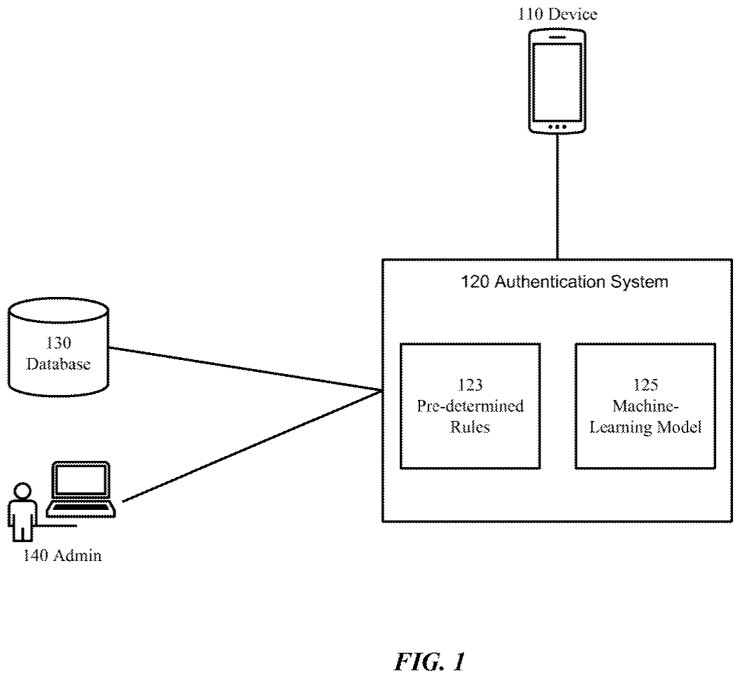

FIG. 1 illustrates an example logical architecture for determining whether a device is malicious when the device is being registered to be used for MFA of an account. A device 110 may send a request for being registered to be used for MFA of an account to an authentication system 120. In particular embodiments, the authentication system 120 may be a part of an information system the account is associated with. In particular embodiments, the authentication system 120 may be a system of an authentication service provider. The authentication system 120 may provide MFA for authenticating accounts. The authentication system 120 may be communicatively connected to a database 130 that contains information associated with the account. In particular embodiments, the database 130 may be a single database. In particular embodiments, the database 130 may be distributed over multiple entities. In particular embodiments, at least a part of the database 130 may belong to the authentication system 120. In particular embodiments, at least a part of the database 130 may belong to the information system the account is associated with. The authentication system 120 may include one or more pre-determined rules 123 and one or more pre-trained machine-learning models 125. The authentication system 120 may utilize the one or more pre-determined rules 123 and the one or more pre-trained machine-learning models 125 to calculate a likelihood of the device 110 being malicious. Once the calculated likelihood is higher than a pre-determined threshold, the authentication system 120 may send a notification to a system associated with an administrator 140. The administrator 140 may take further action to make a final determination whether the device is malicious upon receiving the notification from the authentication system 120. Although this disclosure describes a particular architecture for determining whether a device is malicious when the device is being registered to be used for MFA of an account, this disclosure contemplates any suitable architecture for determining whether a device is malicious when the device is being registered to be used for MFA of an account.

In particular embodiments, an authentication system 120 for providing multi-factor authentication (MFA) may determine whether a device 110 being registered to be used for MFA of an account is malicious based on device properties and account properties. The authentication system 120 may receive a request for registering a device 110 that is to be used for MFA of an account. The authentication system 120 may receive a plurality of device properties from the device 110. The plurality of device properties may include static device properties and dynamic device properties. The static device properties may include properties associated with the device hardware including, but not limited to, a device type, a device model, a list of hardware components within the device 110, or any suitable device property. The dynamic device properties may include an operating system of the device 110, a phone number, a list of installed applications, records of previous events associated with the device 110, or any suitable device property that may change over time. The authentication system 120 may retrieve a plurality of account properties. The plurality of account properties may include account status properties and account history properties. The account status properties may include information associated with an organization of the account, current state of the account, a list of devices registered for the account, or any suitable account status property. The account history properties may include records of previous authentications of the account. Each of the records of previous authentications may include an identity of an authentication device used for the authentication, a plurality of device properties associated with the authentication device, a time of the authentication, a location of the authentication device when the authentication occurs, one or more authentication methods used for the authentication, or any suitable information associated with an authentication. In particular embodiments, the authentication system 120 may calculate a likelihood for the device 110 being malicious. Calculating the likelihood may include processing the plurality of device properties and the plurality of account properties with one or more pre-determined rules. Each of the one or more pre-determined rules may define a set of conditions associated with a corresponding known attack pattern. The set of conditions may include conditions associated with a subset of the plurality of device properties and the plurality of account properties. The pre-determined rule may calculate a probability for the device registration being malicious based on similarities between the conditions associated with the subset and property values of the subset of the plurality of device properties and the plurality of account properties. Calculating the likelihood may further include processing the plurality of device properties and the plurality of account properties with one or more pre-trained machine-learning models. The one or more pre-trained machine-learning models may be classifiers that compute a probability for the device registration being malicious by processing input associated with the device. The input may include one or more of the plurality of device properties. In particular embodiments, the input may further include one or more of the plurality of account properties. The authentication system 120 may determine that the calculated likelihood exceeds a pre-determined threshold. When the calculated likelihood exceeds the pre-determined threshold, the authentication system 120 may send a notification indicating that the calculated likelihood for the device registration being malicious exceeds the pre-determined threshold. When the calculated likelihood does not exceed the pre-determined threshold, the authentication system 120 may register the device for being used for MFA of the account.

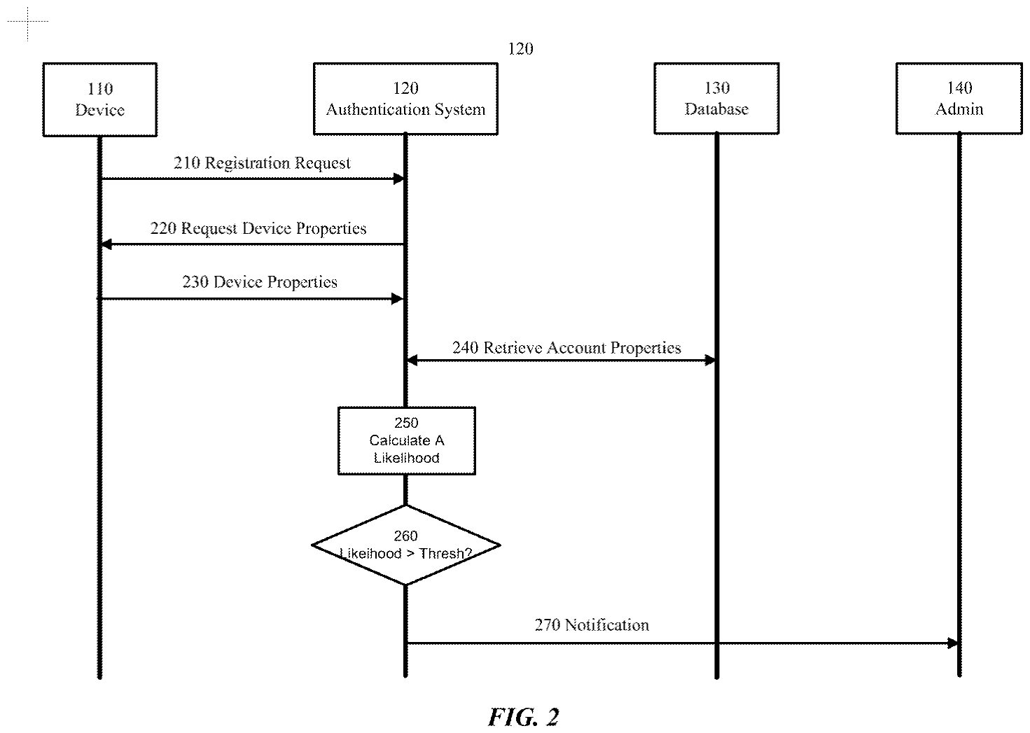

In particular embodiments, the authentication system 120 may receive a request for registering a device 110 that is to be used for MFA of an account from the device 110. FIG. 2 illustrates an example message flow for determining whether a device is malicious when the device is being registered to be used for MFA of an account. As an example and not by way of limitation, as illustrated in FIG. 2, the authentication system 120 may receive a registration request from the device 110 at step 210. The registration request may be for registering the device 110 to be used for MFA of an account. The registration request message may include at least an identity of the account. The device may be a desktop computer, a laptop computer, a smartphone, a tablet computer, a wearable device including a smart watch, or any suitable device that can be used for MFA. The registration requestion message may include an identification of the device 110. Although this disclosure describes receiving a request for registering a device that is to be used for MFA of an account in a particular manner, this disclosure contemplates receiving a request for registering a device that is to be used for MFA of an account in any suitable manner.

In particular embodiments, the authentication system 120 may receive a plurality of device properties from the device 110. The plurality of device properties may include static device properties and dynamic device properties. The static device properties may include properties associated with the device hardware including, but not limited to, a device type, a device model, a list of hardware components within the device 110, or any suitable device property. The dynamic device properties may include an operating system of the device 110, a phone number, a list of installed applications, records of previous events associated with the device 110, or any suitable device property that may change over time. As an example and not by way of limitation, continuing with a prior example, at step 220, the authentication system 120, upon receiving the registration request, may send a request message to the device 110 requesting device properties. In particular embodiments, the request message may include a list of requested device properties. At step 230, the authentication system 120 may receive device properties from the device 110. The received device properties may include static device properties and dynamic device properties. The static device properties may be mainly associated with the hardware of the device 110. The examples of static device properties include, but not limited to, a device type, a manufacturer, and a model of the device 110, a device identifier, such as International Mobile Equipment Identity (IMEI), or a list of hardware components connected with the device 110. The device type may indicate a type of the device 110 such as desktop, laptop, tablet computer, or smartphone. The manufacturer and the model of the device 110 may be in string format. The hardware components connected with the device 110 may include sensors such as cameras, fingerprint scanners, audio/video output devices, or any attached hardware components. The list of hardware components may also include a status of each listed hardware components. The status may be active, disabled, defected, or any suitable status of a hardware component. The dynamic device properties may include properties that may change over time. The dynamic device properties may include, but not limited to, an operation system, a phone number, an Integrated Circuit Card Identification (ICCID), a list of installed applications on the device 110, or record of previous events associated with the device 110. A property associated with the operating system may include an identifier of a current running operating system on the device 110, its version, and a status such as whether rooted or not. The phone number and/or ICCID may be assigned to the device 110 by a cellular service provider. In particular embodiments, the list of installed applications may be a string including the list of installed applications. In particular embodiments, the list of installed applications may be indications whether each in the pre-configured application list is installed. The pre-configured application list may be provided to the device in the request message sent in step 220. In particular embodiments, the record of previous events may be a system log maintained by the device 110. In particular embodiments, the record of previous events may be a list of events that occurred on the device 110 that are identified by a pre-configured event list. The pre-configured event list may be provided to the device 110 in the request message sent in step 220. While the example illustrated in FIG. 2 shows additional message exchanges, as in steps 220 and 230, for receiving the device properties from the device 110, the device 110 may provide the device properties in the registration request message in step 210. Although this disclosure describes receiving a plurality of device properties in a particular manner, this disclosure contemplates receiving a plurality of device properties in any suitable manner.

In particular embodiments, the authentication system 120 may retrieve a plurality of account properties. The plurality of account properties may include account status properties and account history properties. The account status properties may include information associated with an organization of the account, current state of the account, a list of devices registered for the account, or any suitable account status property. The account history properties may include records of previous authentications of the account. Each of the records of previous authentications may include an identity of an authentication device used for the authentication, a plurality of properties associated with the authentication device, a time of the authentication, a location of the authentication device when the authentication occurs, one or more authentication methods used for the authentication, or any suitable information associated with an authentication. As an example and not by way of limitation, continuing with a prior example, the authentication system 120, upon receiving the registration request from the device 110 in step 210, may retrieve account properties from the database 130 in step 240. In particular embodiments, the database 130 may be a single database. In particular embodiments, the database 130 may be distributed over multiple entities. In particular embodiments, at least a part of the database 130 may belong to the authentication system 120. In particular embodiments, at least a part of the database 130 may belong to the information system the account is associated with. To retrieve the account properties from the database 130, the authentication system 120 may exchange messages with the database 130 until all the required account properties are retrieved. The account properties may include account status properties and account history properties. The account status properties may include information associated with the information system associated with the account. The account status properties may also include current status of the account including an indication of whether the account is active, dormant, or suspended, a role of the account within the information system, and a list of resources the account is permitted to access. The account status properties may also include a list of devices registered to be used for MFA of the account. The account history properties may include records of previous MFA of the account within a pre-determined period of time. The pre-determined period of time may be configured by the authentication system 120. Each record of a previous MFA may include an identity of an authentication device used for the MFA. The record may also include a plurality of device properties associated with the authentication device used for the MFA as well as information associated with the MFA including a time of the MFA, a location of the authentication device when the MFA occurred, a used MFA method such as an email, short message service (SMS), biometric authentication, etc. Although this disclosure describes retrieving account properties in a particular manner, this disclosure contemplates retrieving account properties in any suitable manner.

In particular embodiments, the authentication system 120 may calculate a likelihood for the device 110 being malicious. In particular embodiments, the authentication system 120 may utilize one or more pre-determined rules 123 to calculate the likelihood. Each of the one or more pre-determined rules 123 may define a set of conditions associated with a corresponding known attack pattern. The set of conditions may include conditions associated with a subset of the plurality of device properties and the plurality of account properties. The pre-determined rule 123 may calculate a probability for the device 110 being malicious based on similarities between the conditions associated with the subset and property values of the subset of the plurality of device properties and the plurality of account properties. As an example and not by way of limitation, continuing with a prior example, the authentication system 120 may calculate a likelihood for the device 110 being malicious in step 250. The authentication system 120 may calculate a probability for the device 110 being malicious using each of the one or more pre-determined rules 123. Each pre-determined rule 123 defines a set of conditions associated with a known attack pattern. For example, when recent authentication records for the account contains a number of failed attempts, a first pre-determined rule 123 may calculate a high probability of the device 110 being malicious. When the device 110 is a smartphone with a rooted operating system, a second pre-determined rule 123 may calculate a high probability of the device 110 being malicious. When the device 110 is a model equipped with a fingerprint scanner, but the fingerprint scanner is disabled, a third pre-determined rule 123 may calculate a high probability of the device 110 being malicious. When an operating system running on the device 110 is unusually outdated, a fourth pre-determined rule 123 may calculate a high probability of the device registration being malicious. When the organization the account belong to operates in a single country and a phone number associated with the device 110 is a number from a foreign country, a fifth pre-determined rule 123 may calculate a high probability of the device registration being malicious. While only a few examples are disclosed herein, the disclosure contemplates any suitable conditions defined against a corresponding known attack pattern. A pre-determined rule 123 may calculate the probability based on similarities between the defined conditions and property values associated with a device registration. Although this disclosure describes calculating a likelihood for a device registration being malicious using one or more pre-determined rules in a particular manner, this disclosure contemplates calculating a likelihood for a device registration being malicious using one or more pre-determined rules in any suitable manner.

In particular embodiments, calculating the likelihood may further include processing the plurality of device properties and the plurality of account properties with one or more pre-trained machine-learning models 125. The one or more pre-trained machine-learning models 125 may be classifiers that compute a probability for the device 110 being malicious by processing input associated with the device 110. The input may include one or more of the plurality of device properties. In particular embodiments, the input may further include one or more of the plurality of account properties. As an example and not by way of limitation, continuing with a prior example, one of the one or more pre-trained machine-learning models 125 may be a binary classifier that generates a probability for a device registration being malicious based on input associated with the attempted device registration. In particular embodiments, one of the one or more pre-trained machine-learning models 125 may be a deep neural network (DNN) classifier. In particular embodiments, one of the one or more pre-trained machine-learning models 125 may be a convolutional neural network (CNN) classifier. In particular embodiments, one of the one or more pre-trained machine-learning models 125 may be a classifier with Transformer architecture. In particular embodiments, the input to the one or more pre-trained machine-learning models 125 may be device properties associated with the device 110. In particular embodiments, the input to the one or more pre-trained machine-learning models 125 may be account properties associated with the account the device 110 is attempting to registered for. In particular embodiments, the input to the one or more pre-trained machine-learning models 125 may be a combination of a part of the device properties and a part of the account properties. The device properties and/or the account properties may be compiled to be in an input format. The input to the one or more pre-trained machine-learning models 125 may be normalized. Although this disclosure describes calculating a probability for the device registration being malicious using one or more pre-trained machine-learning models in a particular manner, this disclosure contemplates calculating a probability for the device registration being malicious using one or more pre-trained machine-learning models in any suitable manner.

In particular embodiments, the authentication system 120 may determine the likelihood based on the one or more probabilities calculated by the one or more pre-determined rules 123 and a probability calculated by the one or more pre-trained machine-learning models 125. As an example and not by way of limitation, the authentication system 120 may choose a highest probability as the likelihood. As another example and not by way of limitation, the authentication system 120 may compute an average of the calculated probability as the likelihood. As yet another example and not by way of limitation, the authentication system 120 may generate the likelihood by applying a pre-determined formula to the calculated probabilities. Although this disclosure describes generating a likelihood based on probabilities calculated by the one or more pre-determined rules and one or more pre-trained machine-learning models in particular manners, this disclosure contemplates generating a likelihood based on probabilities calculated by the one or more pre-determined rules and one or more pre-trained machine-learning models in any suitable manner.

In particular embodiments, the authentication system 120 may determine that the calculated likelihood exceeds a pre-determined threshold. When the calculated likelihood exceeds the pre-determined threshold, the authentication system 120 may send a notification indicating that the calculated likelihood for the device 110 being malicious exceeds the pre-determined threshold. When the calculated likelihood does not exceed the pre-determined threshold, the authentication system 120 may register the device 110 for being used for MFA of the account. A tradeoff may be considered in determining the pre-determined threshold. With a too high threshold, malicious device registrations may not be filtered. With a too low threshold, the system associated with the administrator 140 may receive too many notifications. As an example and not by way of limitation, continuing with a prior example, the authentication system 120 may determine whether the calculated likelihood exceeds the pre-determined threshold at step 260. When the calculated likelihood exceeds the pre-determined threshold, the authentication system 120 may send a notification to the system associated with the administrator 140 indicating that the calculated likelihood for the device 110 being malicious exceeds the pre-determined threshold in step 270. Upon receiving the notification, the administrator may take further action to determine whether the device 110 is indeed malicious. When the calculated likelihood does not exceed the pre-determined threshold, the authentication system 120 may register the device 110 for being used for MFA of the account. Although this disclosure describes sending a notification when the calculated likelihood exceeds a pre-determined threshold in a particular manner, this disclosure contemplates sending a notification when the calculated likelihood exceeds a pre-determined threshold in any suitable manner.

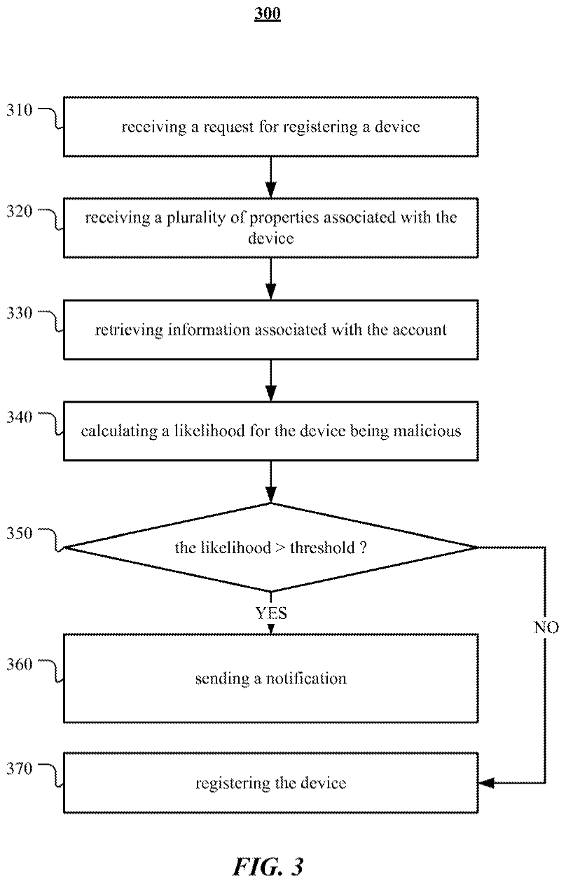

FIG. 3 illustrates an example method 300 for determining whether a device is malicious when the device is being registered to be used for MFA of an account. The method may begin at step 310, where a system may receive a request for registering a device that is to be used for multi-factor authentication (MFA) of an account. At step 320, the system may receive a plurality of device properties from the device. At step 330, the system may retrieve a plurality of account properties. At step 340, the system may calculate a likelihood for the device registration being malicious by processing the plurality of device properties and the plurality of account properties with one or more pre-determined rules and with one or more pre-trained machine-learning models. At step 350, the system may determine whether the calculated likelihood exceeds a pre-determined threshold. When the calculated likelihood exceeds the pre-determined threshold, the method proceeds to step 360, where the system may send a notification indicating that the calculated likelihood for the device registration being malicious exceeds the pre-determined threshold. When the calculated likelihood does not exceed the pre-determined threshold, the method proceeds to step 370, where the system may proceed to register the device to be used for MFA of the account. Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method for determining whether a device is malicious when the device is being registered to be used for MFA of an account including the particular steps of the method of FIG. 3, this disclosure contemplates any suitable method for determining whether a device is malicious when the device is being registered to be used for MFA of an account including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

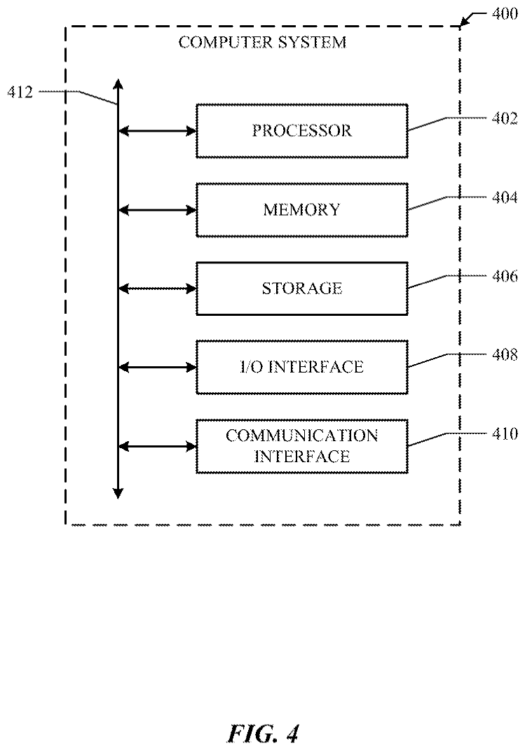

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method, comprising:
receiving a request for registering a device that is to be used for multi-factor authentication (MFA) of an account;
receiving, from the device, a plurality of device properties;
retrieving a plurality of account properties;
calculating a likelihood for a device registration associated with the device being malicious by processing the plurality of device properties and the plurality of account properties with one or more pre-determined rules and with one or more pre-trained machine-learning models;
determining that the likelihood exceeds a pre-determined threshold; and
sending, in response to determining that the likelihood exceeds the pre-determined threshold, a notification indicating that the likelihood for the device registration being malicious exceeds the pre-determined threshold.

2. The method of claim 1, wherein the plurality of device properties comprise static device properties and dynamic device properties.

3. The method of claim 2, wherein the static device properties comprise a device type, a device model, or a list of hardware components within the device.

4. The method of claim 2, wherein the dynamic device properties comprise an operating system of the device, a phone number, a list of installed applications, or records of previous events associated with the device.

5. The method of claim 1, wherein the plurality of account properties comprise account status properties and account history properties.

6. The method of claim 5, wherein the account status properties comprise information associated with an organization of the account, a current state of the account, or a list of devices registered for the account.

7. The method of claim 6, wherein the account history properties comprise records of previous authentications of the account, wherein each of the records comprises an identity of an authentication device used for an authentication, a plurality of properties associated with the authentication device, a time of the authentication, a location of the authentication device when the authentication occurs, or one or more authentication methods used for the authentication.

8. The method of claim 7, wherein each of the one or more pre-determined rules defines a set of conditions associated with a corresponding known attack pattern, wherein the set of conditions comprises conditions associated with a subset of the plurality of device properties and the plurality of account properties.

9. The method of claim 8, wherein the pre-determined rule calculates a probability for the device registration being malicious based on similarities between the conditions associated with the subset and property values of the subset.

10. The method of claim 1, wherein one of the one or more pre-trained machine-learning models is a classifier computing a probability for the device registration being malicious by processing input associated with the device.

11. The method of claim 10, wherein the input comprises one or more of the plurality of device properties.

12. The method of claim 11, wherein the input further comprises one or more of the plurality of account properties.

13. A system comprising: one or more processors; and a non-transitory memory coupled to the one or more processors comprising instructions executable by the one or more processors, the one or more processors operable when executing the instructions to:
receive a request for registering a device that is to be used for multi-factor authentication (MFA) of an account;
receive, from the device, a plurality of device properties;
retrieve a plurality of account properties;
calculate a likelihood for a device registration associated with the device being malicious by processing the plurality of device properties and the plurality of account properties with one or more pre-determined rules and with one or more pre-trained machine-learning models;
determine that the likelihood exceeds a pre-determined threshold; and
send, in response to determining that the likelihood exceeds the pre-determined threshold, a notification indicating that the likelihood for the device registration being malicious exceeds the pre-determined threshold.

14. The system of claim 13, wherein the plurality of device properties comprise static device properties and dynamic device properties.

15. The system of claim 14, wherein the static device properties comprise a device type, a device model, or a list of hardware components within the device.

16. The system of claim 14, wherein the dynamic device properties comprise an operating system of the device, a phone number, a list of installed applications, or records of previous events associated with the device.

17. The system of claim 13, wherein the plurality of account properties comprise account status properties and account history properties.

18. The system of claim 17, wherein the account status properties comprise information associated with an organization of the account, current state of the account, or a list of devices registered for the account.

19. The system of claim 18, wherein the account history properties comprise records of previous authentications of the account, wherein each of the records comprises an identity of an authentication device used for an authentication, a plurality of properties associated with the authentication device, a time of the authentication, a location of the authentication device when the authentication occurs, or one or more authentication methods used for the authentication.

20. One or more computer-readable non-transitory storage media embodying software that is operable when executed to:
receive a request for registering a device that is to be used for multi-factor authentication (MFA) of an account;
receive, from the device, a plurality of device properties;
retrieve a plurality of account properties;
calculate a likelihood for a device registration associated with the device being malicious by processing the plurality of device properties and the plurality of account properties with one or more pre-determined rules and with one or more pre-trained machine-learning models;
determine that the likelihood exceeds a pre-determined threshold; and
send, in response to determining that the likelihood exceeds the pre-determined threshold, a notification indicating that the likelihood for the device registration being malicious exceeds the pre-determined threshold.
